(19) United States
(12) Patent Application Publication
(10) Pub. No.: US 2008/0061716 A1
(43) Pub. Date: Mar. 13, 2008

(54) Backlight unit and crystal display device using the same

(75) Inventors: Pu Jin Kim, Gyeongsangbuk-Do (KR); Seung Hyun Kim, Seoul (KR)

Correspondence Address: BRINKS HOFER GILSON & LIONE, P.O. BOX 10395, CHICAGO, IL, 60610, US

(73) Assignee: LG. Philips LCD CO. LTD.

(21) Appl. No.: 11/895,572

(22) Filed: Aug. 24, 2007

(30) Foreign Application Priority Data
Sep. 12, 2006 (KR) P2006-087848

(51) Int. Cl. H05B 37/02

(52) U.S. Cl. 315/307

(57) ABSTRACT

A backlight unit provides white light for a display device. A light emitting unit may include light emitting diodes (LEDs). The light emitting unit may be combined with a power supplying unit and a current balancing unit to improve the white balance of the light emitted from the LEDs and simplify the circuitry of the backlight unit. The light emitted from the light emitting unit may be balanced due in part to the current balancing unit.

### PRIORITY CLAIM

This application claims the benefit of Korean Patent Application No. 10-2006-087848 filed on Sep. 12, 2006, which is hereby incorporated by reference as if fully set forth herein.

### BACKGROUND

1. Field of the Disclosure

Embodiments of the present disclosure relate to a backlight unit, which may be used in a display device, such as an LCD device. More specifically, a backlight unit with a simplified circuit structure may generate a white light by improving a white balance.

2. Discussion of the Related Art

A liquid crystal display (LCD) device may be comprised of an LCD panel which includes a plurality of liquid crystal cells arranged in a matrix configuration. A plurality of control switches may switch video signals supplied to the respective liquid crystal cells. A backlight unit emits light to the LCD panel. The LCD device displays desired images on a screen by controlling the transmittance of light.

There is a trend towards a reduction in size of the backlight unit. In particular, both the thickness and weight of backlight units are being reduced. Accordingly, a light-emitting diode (LED) may replace a fluorescent lamp since the LED is advantageous for its power consumption, weight and luminance. FIG. 1 is a schematic description of a backlight unit using a related art light-emitting diode (LED). The related art backlight unit is comprised of a light-emitting unit 10 to emit a white light by using red, green and blue light-emitting diodes (LEDs) and a power source circuit 20 to drive the light-emitting unit 10. The light-emitting unit 10 is comprised of a first LED array 121 including a plurality of red LEDs (RLED1 to RLEDn) connected in series; a second LED array 122 including a plurality of green LEDs (GLED1 to GLEDn) connected in series; and a third LED array 123 including a plurality of blue LEDs (BLED1 to BLEDn) connected in series.

The power source circuit 20 includes first to third power sources 221, 222 and 223 which generate driving currents to respectively drive the first to third LED arrays 121, 122 and 123. The first power source 221 generates the first driving current (ir) to drive the first LED array 121 based on a control signal of a first controller (not shown) using a power source voltage (Vin) inputted from the external. The second power source 222 generates the second driving current (ig) to drive the second LED array 122 based on a control signal of a second controller (not shown) using a power source voltage (Vin) inputted from the external. The third power source 223 generates the third driving current (ib) to drive the third LED array 123 based on a control signal of a third controller (not shown) using a power source voltage (Vin) inputted from the external.

The plurality of red LEDs (RLED1 to RLEDn) are connected in series between an output terminal of a first power source 221 and a ground voltage source, whereby the plurality of red LEDs (RLED1 to RLEDn) are driven by the first driving current (ir) supplied from the first power source 221, thereby generating a red light.

The plurality of green LEDs (GLED1 to GLEDn) are connected in series between an output terminal of a second power source 222 and a ground voltage source, whereby the plurality of green LEDs (GLED1 to GLEDn) are driven by the second driving current (ig) supplied from the second power source 222, thereby generating a green light.

The plurality of blue LEDs (BLED1 to BLEDn) are connected in series between an output terminal of a third power source 223 and a ground voltage source, whereby the plurality of blue LEDs (BLED1 to BLEDn) are driven by the third driving current (ib) supplied from the third power source 223, thereby generating a blue light.

The related art backlight unit generates a white light by mixing the red light generated by the red LEDs (RLED1 to RLEDn), the green light generated by the green LEDs (GLED1 to GLEDn) and the blue light generated by the blue LEDs (BLED1 to BLEDn). In order to generate the white light by driving the light-emitting unit 10 including the first to third LED arrays 121, 122 and 123, the related art backlight unit includes the three power sources 221, 222 and 223 and the three controllers. The circuit structure may be complicated and expensive. In addition, the first to third LED arrays 121, 122 and 123 are separately driven by other power sources 221, 222 and 223, so that it may be difficult to maintain the white balance.

### BRIEF SUMMARY

In a first aspect, a backlight unit includes a first light emitting diode (LED), a second LED, and a third LED. A power supplying unit is configured to provide a current to the first LED, the second LED and the third LED. A controlling unit is coupled with the power supplying unit and configured to control the current provided by the power supplying unit. A current balancing unit receives an output current from the first LED, the second LED, and the third LED. The current balancing unit is configured to provide a feedback line to the controlling unit based on the output currents. The controlling unit controls the current provided by the power supplying unit based on the feedback line.

In a second aspect, a backlight unit includes a controlling unit and a power supplying unit controlled by the controlling unit. A light emitting unit includes a plurality of light emitting diodes (LEDs) receiving current from the power supplying unit. A current balancing unit receives an output current from the plurality of LEDs and provides a feedback signal to the controlling unit. The controlling unit controls the power supplying unit based on the feedback signal from the current balancing unit.

In a third aspect, a method for emitting a backlight for a display includes providing a single driving current to a light emitting unit. A white light is emitted from the light emitted unit that is powered by the single driving current. A current emitted from the light emitting unit is measured. A feedback signal is provided based on the current emitted from the light emitting unit. The single driving current to the light emitting unit is controlled based at least in part on the feedback signal. An output of the light emitting unit is adjusted based at least in part on the feedback signal. The control of the driving current and adjustment of the output based on the feedback signal balance a white light level of the white light emitted from the light emitting unit.

It is to be understood that both the foregoing general description and the following detailed description of the present invention are exemplary and explanatory and are intended to provide further explanation of the invention as claimed. Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below in conjunction with the embodiments.

### BRIEF DESCRIPTION OF THE DRAWINGS

The system and/or method may be better understood with reference to the following drawings and description. Non-limiting and non-exhaustive embodiments are described with reference to the following drawings. The components in the figures are not necessarily to scale, emphasis instead being placed upon illustrating the principles of the invention. In the figures, like referenced numerals designate corresponding parts throughout the different views. The accompanying drawings, which are included to provide a further understanding of the invention and are incorporated in and constitute a part of this application, illustrate embodiment(s) of the invention and together with the description serve to explain the principle of the invention. In the drawings:

FIG. 1 shows a schematic description of a backlight unit using a related art light-emitting diode;

FIG. 2 shows a schematic description of a backlight unit according to one embodiment;

FIG. 3 shows a schematic description of a current-balancing unit according to a first embodiment;

FIG. 4 shows a schematic description of a current-balancing unit according to a second embodiment;

FIG. 5 shows a schematic description of a current-balancing unit according to a third embodiment; and

FIG. 6 shows a schematic description of an LCD device according to an embodiment.

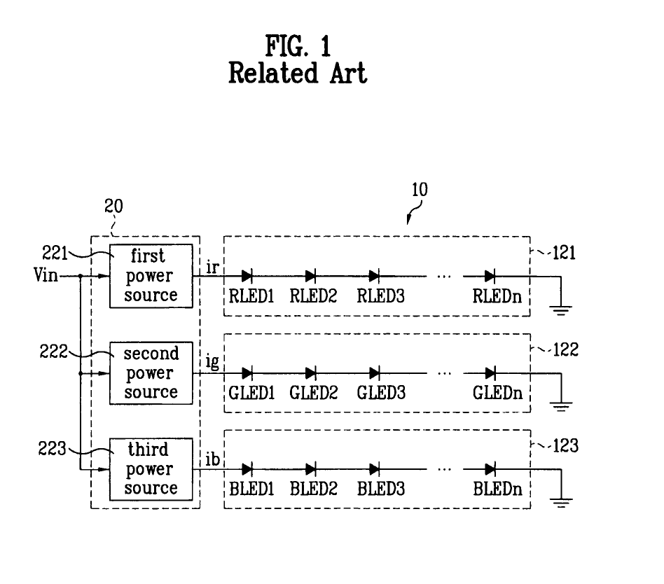

### DETAILED DESCRIPTION

Reference will now be made in detail to exemplary embodiments of the present disclosure, which are illustrated in the accompanying drawings. Wherever possible, the same reference numbers will be used throughout the drawings to refer to the same or like parts.

Hereinafter, a backlight unit according to the present disclosure will be described with reference to the accompanying drawings. The backlight unit may be used in a display device, such as an LCD device.

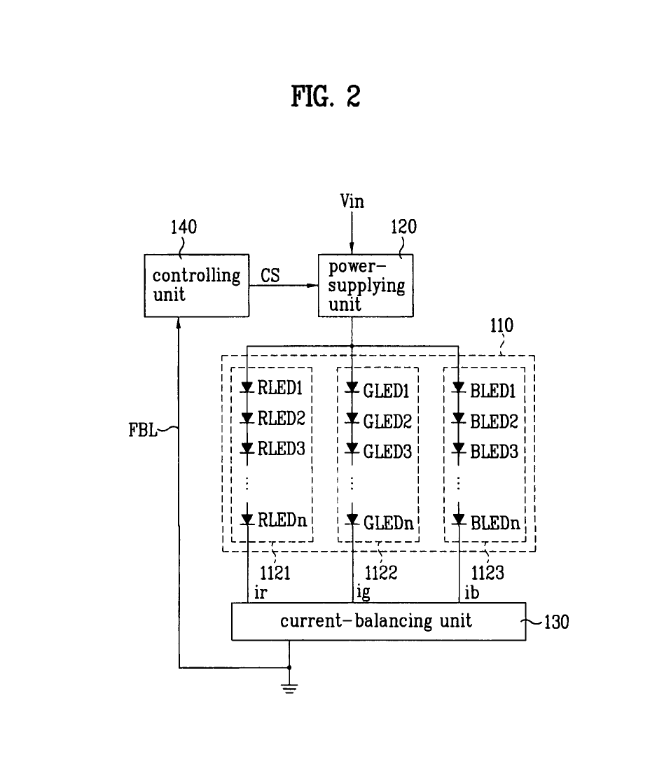

FIG. 2 shows a schematic description of a backlight unit according to an embodiment of the present disclosure. Referring to FIG. 2, the backlight unit according to one embodiment includes a light-emitting unit 110 to emit a white light by using red, green and blue light-emitting diodes (LED) arrays 1121, 1122 and 1123; a power-supplying unit 120 to supply a driving current to the red, green and blue LED arrays 1121, 1122 and 1123; a current-balancing unit 130 to maintain a white balance by controlling a current in each of the red, green and blue LED arrays 1121, 1122 and 1123; and a controlling unit 140 to control the power-supplying unit 120 based on a feedback signal outputted from the current-balancing unit 130.

The power-supplying unit 120 generates the driving current to drive the red, green and blue LED arrays 1121, 1122 and 1123 under control of the controlling unit 140. The power-supplying unit 120 supplies the generated driving current to the red, green and blue LED arrays 1121, 1122 and 1123. An output terminal of the power-supplying unit 120 is connected to the red, green and blue LED arrays 1121, 1122 and 1123.

The light-emitting unit 110 generates a white light by mixing red, green and blue lights respectively generated by the red, green and blue LED arrays 1121, 1122 and 1123. In other words, the light-emitting unit 110 emits white light based on the combination of at least one red LED, green LED, and blue LED. In alternative embodiments, there may be more or fewer combinations of LEDs in the light-emitting unit 110, and the colors or types of LEDs may vary. In addition, the source of the light may be different than a light emitting diode (LED). The light-emitting unit 110 is coupled with and arranged between the power-supplying unit 120 and the current-balancing unit 130 in parallel.

As shown, the red LED array 1121 is comprised of ‘n’ red LEDs (RLED1 to RLEDn) connected between the power-supplying unit 120 and the current-balancing unit 130 in series. Among the ‘n’ red LEDs (RLED1 to RLEDn) connected in series, a cathode terminal of the first red LED (RLED1) is connected to an output terminal of the power-supplying unit 120, and an anode terminal of the ‘n’-th red LED (RLEDn) is connected to the current-balancing unit 130. The red LED array 1121 is operated based on the driving current outputted from the power-supplying unit 120, thereby generating the red light.

The green LED array 1122 is comprised of ‘n’ green LEDs (GLED1 to GLEDn) connected between the power-supplying unit 120 and the current-balancing unit 130 in series. Among the ‘n’ green LEDs (GLED1 to GLEDn) connected in series, a cathode terminal of the first green LED (GLED1) is connected to the output terminal of the power-supplying unit 120, and an anode terminal of the ‘n’-th green LED (GLEDn) is connected to the current-balancing unit 130. The green LED array 1122 is operated based on the driving current outputted from the power-supplying unit 120, thereby generating the green light.

The blue LED array 1123 is comprised of ‘n’ blue LEDs (BLED1 to BLEDn) connected between the power-supplying unit 120 and the current-balancing unit 130 in series. Among the ‘n’ blue LEDs (BLED1 to BLEDn) connected in series, a cathode terminal of the first blue LED (BLED1) is connected to the output terminal of the power-supplying unit 120, and an anode terminal of the ‘n’-th blue LED (BLEDn) is connected to the current-balancing unit 130. The blue LED array 1123 is operated based on the driving current outputted from the power-supplying unit 120, thereby generating the blue light.

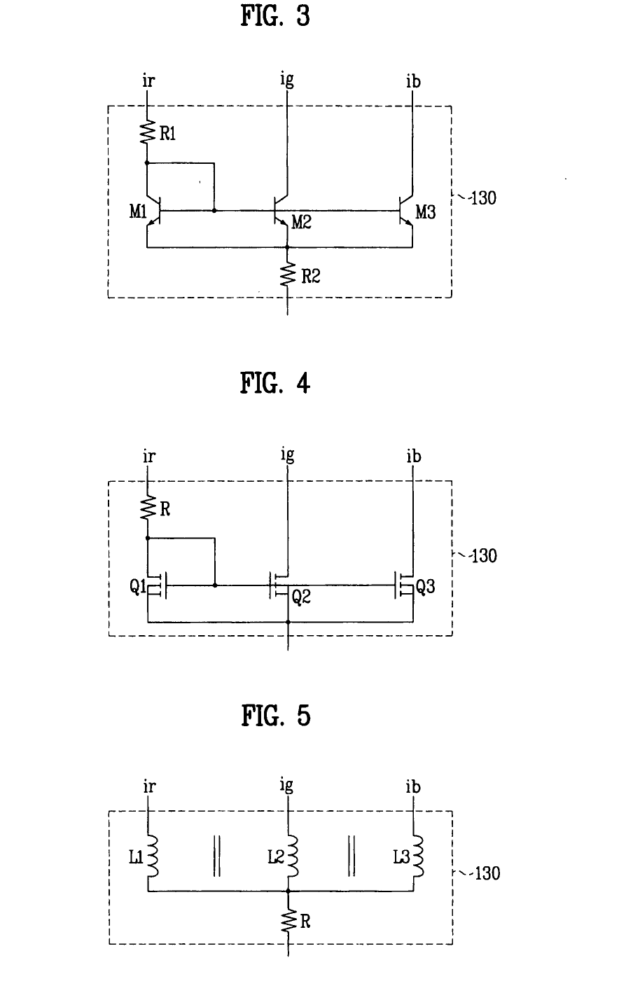

The current-balancing unit 130 is coupled with each of the LED arrays 1121, 1122 and 1123 and a ground voltage source. The current-balancing unit 130 balances the current (ir, ig, ib) passed through the red, green and blue LED arrays 1121, 1122 and 1123 to generate the desired white light by keeping the white balance of light-emitting unit 110. The current balancing unit 130 is discussed below with respect to FIGS. 3-5.

The controlling unit 140 generates a control signal (CS) to control the power-supplying unit 120 based at least in part on the feedback of current flowing to the ground voltage source from the current-balancing unit 130 through a feedback line (FBL). Based on the feedback signal from the feedback line, the controlling unit 140 controls the current flowing to the respective LED arrays 1121, 1122 and 1123 from the power-supplying unit 120 to improve the white level of the light. Accordingly, the power-supplying unit 120 generates the driving current based on the control signal (CS) of controlling unit 140 by using an input power (Vin). The power-supplying unit 120 supplies the driving current to the respective LED arrays 1121, 1122 and 1123.

The backlight unit according to one embodiment of balances the current for the respective LED arrays 1121, 1122 and 1123 by using the current-balancing unit 130. The backlight unit generates white light having the desired white point or white level by maintaining the white balance of light-emitting unit 110. The backlight unit may simplify a circuit structure to drive the red, green and blue LED arrays 1121, 1122 and 1123 by using one power-supplying unit 120 and one controlling unit 140 and further using the current-balancing unit 130.

FIG. 3 shows a circuit diagram illustrating the current-balancing unit 130 according to a first embodiment. Referring to FIG. 3 in connection with FIG. 2, the current-balancing unit 130 according to the first embodiment is controlled by the current (ir) of red LED array 1121. The current-balancing unit 130 is comprised of first to third mirror transistors M1, M2 and M3 connected by a current mirror connection type. Each of the first to third mirror transistors M1, M2 and M3 may be formed of a bipolar transistor.

A base terminal and a collector terminal of the first mirror transistor M1 are connected to one end of the red LED array 1121 by a first resistor R1 in common. An emitter terminal of the first mirror transistor M1 is connected to the ground voltage source by a second resistor R2.

A base terminal of the second mirror transistor M2 is connected to the base terminal of the first mirror transistor M1. A collector terminal of the second mirror transistor M2 is connected to one end of the green LED array 1122. An emitter terminal of the second mirror transistor M2 is connected to the ground voltage source by the second resistor R2.

A base terminal of the third mirror transistor M3 is connected to the base terminal of the first mirror transistor M1. A collector terminal of the third mirror transistor M3 is connected to one end of the blue LED array 1123. An emitter terminal of the third mirror transistor M3 is connected to the ground voltage source by the second resistor R2.

The current-balancing unit 130 controls the currents (ir, ig, ib) for the respective LED arrays 1121, 1122 and 1123 by using the first to third mirror transistors (M1, M2, M3). The current-balancing unit 130 balances the currents (ir, ig, ib) for the respective LED arrays 1121, 1122 and 1123 to keep the white balance of the light emitted from the light emitting unit 110.

In one embodiment, the current for the transistor connected by a current mirror connection type is influenced by a current-amplifying rate (β) of transistor, as shown in the following equation 1.

$$\frac{I o}{I ref} = \frac{1}{1 + 2 / β} \qquad [ equation 1 ]$$

The current-amplifying rate (β) of transistor may be expressed as the following equation 2.

$$β = \frac{1}{\frac{D p}{D n} \frac{{N}_{A}}{{N}_{D}} \frac{W}{L p} + \frac{1}{2} \frac{{W}^{2}}{D n {τ}_{b}}} \qquad [ equation 2 ]$$

In the equation 2, ‘Dn’ is an electron diffusion rate on the base; ‘Dp’ is a hole diffusion rate on the emitter; ‘N_{D}’ is a doping density of emitter; ‘N_{A}’ is a doping density of base; ‘Lp’ is a hole diffusion distance of emitter; ‘W’ is a width of effective base; and ‘T_{b}’ is a minority carrier lifetime on the base. In the above equations 1 and 2, the deviation of current flowing in the respective LED arrays 1121, 1122 and 1123 by the first to third mirror transistors M1, M2 and M3 is influenced by the current-amplifying rate (β1, β2, β3) and the doping density (N_{A}/N_{D}).

Accordingly, the current-balancing unit 130 keeps the white balance for the LED arrays 1121, 1122 and 1123 by using the current-amplifying rate (β1, β2, β3) and the doping density (N_{A}/N_{D}) of the first to third mirror transistors M1, M2 and M3. The adjustments of these variables may allow for the balancing of the white light from the light emitting unit 110.

For example, in order to maintain the white balance of white light generated in the light-emitting unit 110, if the red driving current (ir) of red LED array 1121, the green driving current (ig) of green LED array 1122 and the blue driving current (ib) of blue LED array 1123 appear in the ratio of 1:2:2, the respective base widths of the mirror transistors M1, M2 and M3 appear in the ratio of 1:2:2. The respective current-amplifying rates (β1, β2, β3) of mirror transistors M1, M2 and M3 are then set as 1:2:2. Accordingly, the current-balancing unit 130 sets the current-amplifying rates (β1, β2, β3) of respective mirror transistors M1, M2 and M3 to maintain the desired white balance, thereby setting the current amount for the respective mirror transistors M1, M2 and M3 to keep the white balance on the assumption that the mirror transistors M1, M2 and M3 have the same doping density (N_{A}/N_{D}).

The current-amplifying rates (β1, β2, β3) of respective mirror transistors M1, M2 and M3 may be set based on experimentation used to determine which values result in a white balance. In one example, the current-amplifying rate (β1) of first mirror transistor (M1) may be smaller than the current-amplifying rates (β2, β3) of second and third mirror transistors M2 and M3. Also, the current-amplifying rate (β2) of second mirror transistor M2 may be the same as or smaller than the current-amplifying rate (β3) of third mirror transistor M3.

FIG. 4 shows the circuit diagram of current-balancing unit 130 according to a second embodiment. Referring to FIG. 4 in connection with FIG. 2, the current-balancing unit 130 according to the second embodiment is controlled by the current (ir) of red LED array 1121. The current-balancing unit 130 is comprised of first to third mirror transistors Q1, Q2 and Q3 connected as a current mirror connection type. Each of the first to third mirror transistors Q1, Q2 and Q3 may be formed of a field effect transistor.

Gate and source terminals of the first mirror transistor Q1 are connected to one end of red LED array 1121 by a resistor R in common. A drain terminal of the first mirror transistor Q1 is connected to the ground voltage source. A gate terminal of the second mirror transistor Q2 is connected to the gate terminal of the first mirror transistor Q1. A source terminal of the second mirror transistor Q2 is connected to one end of green LED array 1121. A drain terminal of the second mirror transistor Q2 is connected to the ground voltage source.

A gate terminal of the third mirror transistor Q3 is connected to the gate terminal of first mirror transistor Q1. A source terminal of the third mirror transistor Q3 is connected to one end of blue LED array 1123. A drain terminal of the third mirror transistor Q3 is connected to the ground voltage source. The current-balancing unit 130 controls the currents (ir, ig, ib) flowing in the respective LED arrays 1121, 1122 and 1123 by using the first to third mirror transistors Q1, Q2 and Q3, and balances the currents (ir, ig, ib) flowing in the respective LED arrays 1121, 1122 and 1123 to keep the white balance. In one example, the channel width (W) and length (L) of first to third mirror transistors Q1, Q2 and Q3 may be experimentally set to keep the desired white balance. The channel width (W) and length (L) of first mirror transistor Q1 mayf be smaller than the channel width (W) and length (L) of second and third mirror transistors Q2 and Q3. Also, the channel width (W) and length (L) of second mirror transistor Q2 may be the same as or smaller than the channel width (W) and length (L) of third mirror transistor Q3.

FIG. 5 shows the circuit diagram of a current-balancing unit 130 according to the third embodiment. Referring to FIG. 5, the current-balancing unit 130 according to the third embodiment includes a magnetic device which is connected to red, green and blue LED arrays 1121, 1122 and 1123 and compensates for an impedance deflection for the red, green and blue LED arrays 1121, 1122 and 1123. The magnetic device may be a coupling inductor or a multi-channel transformer. The magnetic device is comprised of first to third coils L1, L2 and L3 respectively coupled with the red, green and blue LED arrays 1121, 1122 and 1123 and also coupled with the ground voltage source by a resistor R.

The first to third coils L1, L2 and L3 may have the same winding ratio or different winding ratios to compensate for the impedance deflection of the red, green and blue LED arrays 1121, 1122 and 1123. The current-balancing unit 130 according to the third embodiment compensates for the impedance deflection for the red, green and blue LED arrays 1121, 1122 and 1123, to maintain the desired white balance by adjusting the first to third winding ratios L1, L2 and L3.

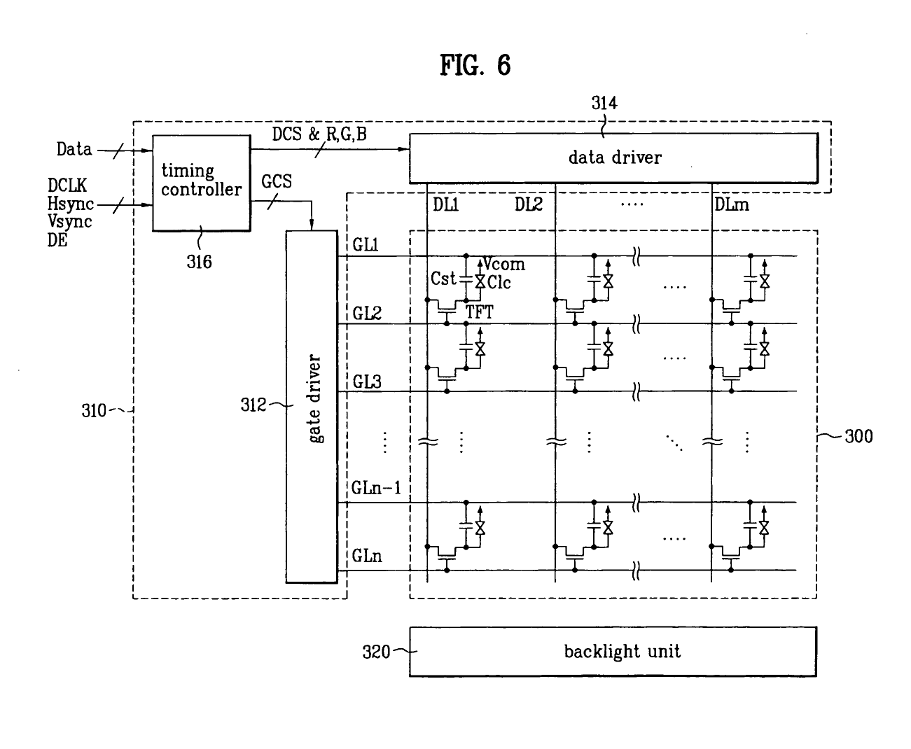

FIG. 6 shows a schematic description of an LCD device according to one embodiment. Referring to FIG. 6, the LCD device includes an image displaying unit 300 provided with liquid crystal cells formed in regions defined by a plurality of gate lines (GL1 to GLn) and data lines (DL1 to DLm). The LCD device further includes a driving circuit unit 310 to display images corresponding to input data (Data) on the image displaying unit 300 and includes a backlight unit 320 to emit the light to the image displaying unit 300.

The image displaying unit 300 includes a plurality of thin film transistors formed in the regions defined by the ‘n’ gate lines (GL1 to GLn) and ‘m’ data lines (DL1 to DLm). The liquid crystal cells are respectively connected to the thin film transistors TFT. The thin film transistors TFT supply video signals of the data lines (DL1 to DLm) to the liquid crystal cells in response to the “gate on” voltages of the gate lines (GL1 to GLn). The liquid crystal cell is comprised of a sub-pixel electrode connected to the common electrode. The sub-pixel electrode and the thin film transistor face each other, such that the liquid crystal is interposed therebetween. The liquid crystal cell is equivalently displayed as a liquid crystal capacitor (Clc). The liquid crystal cell includes a storage capacitor (Cst) which maintains the video signal charged in the liquid crystal capacitor (Clc) until the next video signal is charged.

The driving circuit unit 310 includes a gate driver 312 which generates a “gate on” voltage based on a gate control signal (GCS), and supplies the “gate on” voltage to the gate lines (GL1 to GLn) in sequence. A data driver 314 converts input data (Data) to video signals according to a data control signal (DCS), and supplies the video signals to the corresponding data lines (DL1 to DLm) in synchronization with the “gate on” voltage. A timing controller 316 supplies the aligned input data (Data) to the data driver 314, and controls the gate and data drivers 312 and 314.

The gate driver 312 generates the “gate on” voltage based on the gate control signal (GCS) outputted from the timing controller 316, which may be a gate high pulse in sequence. The generated “gate on” voltage is supplied to the gate lines (GL1 to GLn) in sequence. In response to the “gate on” voltage, the thin film transistor (TFT) is turned-on.

The data driver 314 converts data (R, G, B) supplied from the timing controller 316 into analog video signals based on the data control signal (DCS) supplied from the timing controller 316. The data driver 314 supplies the analog video signal for one horizontal line to the data lines (DL1 to DLm) by each horizontal period. The data driver 314 then inverts the polarity of the video signal supplied to the data lines (DL1 to DLm) in response to a polarity control signal. The timing controller 316 aligns the input data (Data) to be suitable for driving the image displaying unit 300, and supplies the aligned data to the data driver 314.

The timing controller 316 generates the gate control signal (GCS) to control the driving timing of gate driver 312 and the data control signal (DCS) to control the driving timing of data driver 314 by using synchronization signals inputted externally. The synchronization signals may be least one of a dot clock (DCLK), a data enable signal (DE), or a horizontally or vertically synchronized signal (Hsync and Vsync).

The backlight unit 320 generates the white light by mixing the red light generated by at least one of red LEDs, the green light generated by at least one of the green LEDs, and the blue light generated by at least one of the blue LEDs, and supplies the generated white light to the image displaying unit 300. The backlight unit 320 may be identical in structure to the backlight unit as described with respect to FIG. 2. The backlight unit 320 may include any one of the current-balancing units according to the first to third embodiments shown in FIG. 3 to 5. The LCD device according to the preferred embodiment of the present disclosure controls the transmittance of light emitted from the backlight unit 320 according to the video signal supplied from the image displaying unit, and displays the desired images on the image displaying unit 300.

For the LCD device according to the embodiments discussed herein, the desired image is displayed using white light having the desired white balance by the current-balancing unit, thereby improving the picture quality. As mentioned above, the backlight unit according to one embodiment and the LCD device using the same it is possible to balance the current for the red, green and blue LED arrays by the current-balancing unit. This generates a white light having the desired white point or white level by keeping the white balance. In addition, the red, green and blue LED arrays may be driven by one power source and one controller using the current-balancing unit, to thereby simplify the circuit structure.

It will be apparent to those skilled in the art that various modifications and variations can be made in the embodiments of the present invention without departing from the spirit or scope of the invention. Thus, it is intended that the present invention covers the modifications and variations of the embodiments provided they come within the scope of the appended claims and their equivalents.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A backlight unit comprising:
a light-emitting unit to generate a white light using red, green and blue LED arrays;
a power-supplying unit to supply a driving current to the red, green and blue LED arrays; and
a current-balancing unit to keep a white balance by controlling the current flowing in the red, green and blue LED arrays.

2. The backlight unit of claim 1, further comprising a controlling unit to control the power-supplying unit by feedback of the current flowing to a ground voltage source from the current-balancing unit.

3. The backlight unit of claim 2, wherein the current-balancing unit is controlled by the current from one of the red, green or blue LED arrays, and the current-balancing unit is comprised of first to third mirror transistors connected in type of a current mirror.

4. The backlight unit of claim 3, wherein the first to third mirror transistors are formed of bipolar transistors.

5. The backlight unit of claim 4, wherein the first to third mirror transistors have one of the same current-amplifying ratio or a different current-amplifying ratios.

6. The backlight unit of claim 4, wherein the current-amplifying ratio of a first mirror transistor connected to the red LED array is smaller than the current-amplifying ratio of a second mirror transistor connected to the green LED array and the current-amplifying ratio of a third mirror transistor connected to the blue LED array; and the current-amplifying ratio of the second mirror transistor is the same as or smaller than the current-amplifying ratio of the third mirror transistor.

7. The backlight unit of claim 3, wherein the first to third mirror transistors are formed of field effect transistors.

8. The backlight unit of claim 7, wherein the first to third mirror transistors have the same channel width (W) and length (L) or the different channel widths (W) and lengths (L).

9. The backlight unit of claim 7, wherein the channel width (W) and length (L) of first mirror transistor connected to the red LED array are smaller than the channel width (W) and length (L) of second mirror transistor connected to the green LED array and the channel width (W) and length (L) of third mirror transistor connected to the blue LED array; and the channel width (W) and length (L) of second mirror transistor are the same as or smaller than the channel width (W) and length (L) of third mirror transistor.

10. The backlight unit of claim 2, wherein the current-balancing unit is comprised of a magnetic device connected to the red, green and blue LED arrays.

11. The backlight unit of claim 10, wherein the magnetic device is formed of one of a coupling inductor or a multi-channel transformer.

12. The backlight unit of claim 11, wherein the magnetic device is comprised of first to third windings respectively connected to the red, green and blue LED arrays.

13. The backlight unit of claim 12, wherein the first to third windings have one of the same winding ratio or a different winding ratios.

14. An LCD device comprising:
an image displaying unit provided with liquid crystal cells formed in regions defined by a plurality of gate lines and data lines;
a driving circuit unit to display images corresponding to input data on the image displaying unit; and
a backlight unit to emit the light to the image displaying unit,
wherein the backlight unit comprises:
a light-emitting unit to generate a white light by using red, green and blue LED arrays;
a power-supplying unit to supply a driving current to the red, green and blue LED arrays; and
a current-balancing unit to keep a white balance by controlling the current flowing in the red, green and blue LED arrays.

15. The LCD device of claim 14, wherein the driving circuit unit comprises:
a gate driver which drives the gate lines in sequence;
a data driver which converts the input data to video signals, and supplies the video signals to the data lines; and
a timing controller which supplies the input data to the data driver, and controls the gate and data drivers.

16. The LCD device of claim 14, further comprising a controlling unit to control the power-supplying unit by feedback of the current flowing to a ground voltage source from the current-balancing unit.

17. The LCD device of claim 16, wherein the current-balancing unit is controlled by the current from one of the red, green and blue LED arrays, and the current-balancing unit is comprised of first to third mirror transistors connected in type of a current mirror.

18. The LCD device of claim 17, wherein the first to third mirror transistors are formed of bipolar transistors.

19. The LCD device of claim 18, wherein the first to third mirror transistors have one of the same current-amplifying ratio or a different current-amplifying ratios.

20. The LCD device of claim 18, wherein the current-amplifying ratio of a first mirror transistor connected to the red LED array is smaller than the current-amplifying ratio of a second mirror transistor connected to the green LED array and the current-amplifying ratio of a third mirror transistor connected to the blue LED array; and the current-amplifying ratio of second mirror transistor is the same as or smaller than the current-amplifying ratio of third mirror transistor.

21. The LCD device of claim 17, wherein the first to third mirror transistors are formed of field effect transistors.

22. The LCD device of claim 21, wherein the first to third mirror transistors have one of the same channel width (W) and length (L) or a different channel widths (W) and lengths (L).

23. The LCD device of claim 21, wherein the channel width (W) and length (L) of a first mirror transistor connected to the red LED array are smaller than the channel width (W) and length (L) of a second mirror transistor connected to the green LED array and the channel width (W) and length (L) of a third mirror transistor connected to the blue LED array; and the channel width (W) and length (L) of second mirror transistor are the same as or smaller than the channel width (W) and length (L) of third mirror transistor.

24. The LCD device of claim 16, wherein the current-balancing unit is comprised of a magnetic device connected to the red, green and blue LED arrays.

25. The LCD device of claim 24, wherein the magnetic device is formed of one of a coupling inductor or a multi-channel transformer.

26. The LCD device of claim 25, wherein the magnetic device is comprised of first to third windings respectively connected to the red, green and blue LED arrays.

27. The LCD device of claim 26, wherein the first to third windings have one of the same winding ratio or a different winding ratios.
